(19) United States
(12) Patent Application Publication
(10) Pub. No.: US 2014/0176810 A1
(43) Pub. Date: Jun. 26, 2014

(54) Multimedia Signal Control Device and Control Method Thereof

(71) Applicant: Much-ip Co., Ltd., Hsinchu County (TW)

(72) Inventors: Shoa-Hung Lo, Hsinchu County (TW); Chia-Hong Hsieh, Hsinchu County (TW); Tung-Shu Yang, Hsinchu County (TW)

(73) Assignee: Much-ip Co., Ltd., Hsinchu County (TW)

(21) Appl. No.: 14/060,801

(22) Filed: Oct. 23, 2013

(30) Foreign Application Priority Data
Dec. 20, 2012 (TW) 101148656

(51) Int. Cl. H04N 5/44

(52) U.S. Cl. CPC H04N 5/44
USPC 348/734

(57) ABSTRACT

A multimedia signal control device including a signal-connecting unit and a remote control unit is disclosed. The signal-connecting unit is used for connecting to a portable data-processing device and to a multimedia playback device. The multimedia signal outputted by either of the connected devices is converted into a converted multimedia signal processible to the other of the connected devices by the signal-connecting unit. The converted multimedia signal is transmitted to the other one of the connected devices. The remote control unit connects to the signal-connecting unit and transmits a control signal to the signal-connecting unit. The signal-connecting unit transmits the control signal to one of the connected devices, so as to control the operation of the connected device.

The current application claims a foreign priority to the patent application of Taiwan No. 101148656 filed on Dec. 20, 2012.

### TECHNICAL FIELD

The present invention relates to signal processing and controlling, and more particularly, to a multimedia signal control device and a controlling method thereof that combine a data-processing device and a multimedia playback device and a controlling method thereof.

### BACKGROUND ART

With the development and popularization of mobile communicating devices and data processing technologies, some portable data-processing devices such as mobile phones and tablet computers have become an important medium for people to obtain information and communicate with each other. As the capability of such portable data-processing devices improves, they, along with the application programs running thereon, provide users with more diverse and convenient daily life.

Taking a mobile phone for example, it allows its user to obtain films and music through wired or wireless transmission and play the obtained contents thereon. While such a mobile device is a convenient tool to play multimedia contents anytime and anywhere, it is limited in both software and hardware supported formats, and the images as well as sounds it presents are unsatisfactory as compared to those shown in a large TV screen and played through a professional-class audio system.

Therefore, when intending to enjoy more lively video and audio presentations, a user usually connects the mobile phone to an external TV set or an audio system and enjoys the multimedia contents stored in the mobile phone through the connected TV set or audio system.

However there are cases in which portable data-processing devices such as mobile phones and the external multimedia playback devices such as TV sets and audio systems are inconsistent in signal format they can transmit or process. For example, a mobile phone may output signals in an MHL (Mobile High-Definition Link) format, while a TV set can only receive and process multimedia signals in an HDMI (High Definition Multimedia Interface) format. In this case, the multimedia signals cannot be transmitted and played unless a signal-converting device connects between the two devices for signal conversion. The same problem also exists between different portable data-processing devices or between different multimedia playback devices.

In such a case, the multimedia signals are played through the TV set under the control of the mobile phone, so the user's location of operation is substantially restricted by the connection between the mobile phone and the TV set (including wired or wireless connection). This hinders the user from freely control playback of the contents.

Thus, it would be desirable to provide a multimedia signal controlling technique that is applicable to the foregoing environment.

### SUMMARY

One aspect of the invention provides a multimedia signal control device. In some embodiments, the multimedia signal control device, which is used for connecting and controlling a portable data-processing device and a multimedia playback device, includes a signal-connecting unit and a remote control unit. The signal-processing unit is used for connecting to the portable data-processing device and to the multimedia playback device, and for converting a multimedia signal outputted by either of portable data-processing device and the multimedia playback device into a converted multimedia signal that is processible to the other, and the signal-connecting unit transmits the converted multimedia signal to the other.

It is also provided in the invention a multimedia signal control device including a signal-connecting unit and a remote control unit. The signal-connecting unit is used for connecting to a portable data-processing device, converting a multimedia signal in a first signal format that is outputted by the portable data-processing device into a second signal format that is recognizable and processible to the multimedia playback device, and transmitting the converted multimedia signal to the multimedia playback device. The remote control unit is used for connecting to a signal-connecting unit and transmitting a control signal to the signal-connecting unit. The remote control unit is also used to direct the signal-connecting unit to transmit the control signal to the portable data-processing device. The portable data-processing device outputs, in response to the control signal, the multimedia signal in the first signal format to the signal-connecting unit. The signal-connecting unit converts the multimedia signal in the first signal format into the multimedia signal in the second signal format and transmits the converted multimedia signal to the multimedia playback device.

In some embodiments, the signal-connecting unit is used for connecting to more than one portable data-processing device or to more than one multimedia playback devices for signal conversion and transmission. The remote control unit is used to control the signal-connecting unit to switch among the portable data-processing devices and/or the multimedia playback devices for signal conversion and transmission.

In another aspect of the invention, a method for controlling a multimedia signal is provided. In the method, a signal-transmitting connection between a portable data-processing device and a multimedia playback device is established by using a signal-connecting unit. A control signal from a remote control unit is received by using the signal-connecting unit, and then the received control signal is transmitted to the portable data-processing device or the multimedia playback device by using the signal-connecting unit. The portable data-processing device or the multimedia playback device is manipulated in accordance with the received control signal.

It is also provided in the invention a method for controlling a multimedia signal, which includes the following steps. A signal-transmitting connection between a portable data-processing device and a multimedia playback device is established by using a signal-connecting unit. A control signal from a remote control unit is received by using the signal-connecting unit. Then the received control signal is transmitted to the portable data-processing device by using the signal-connecting unit. A multimedia signal in a first signal format is transmitted to the signal-connecting unit by using the portable data-processing device in accordance with the received control signal. The multimedia signal in the first signal format is converted into a second signal format by using the signal-connecting unit. The converted multimedia signal is then transmitted to the multimedia playback device by using the signal-connecting unit.

According to the multimedia signal control device and the control method thereof of the invention, the user is able to operate and control the portable data-processing device or the multimedia playback device connected to the signal-connecting unit by using the remote control unit, without direct access to the portable data-processing device. The convenience and usability are increased.

### BRIEF DESCRIPTION OF DRAWINGS

FIG. 1 is a schematic diagram of a multimedia signal control device according to an embodiment of the invention.

FIG. 2 is a flowchart of a method for controlling a multimedia signal using the multimedia signal control device according to a first embodiment of the invention.

FIG. 3 is a flow chart of a method for controlling a multimedia signal using the multimedia signal control device according to a second embodiment of the invention.

### DETAIL DESCRIPTION

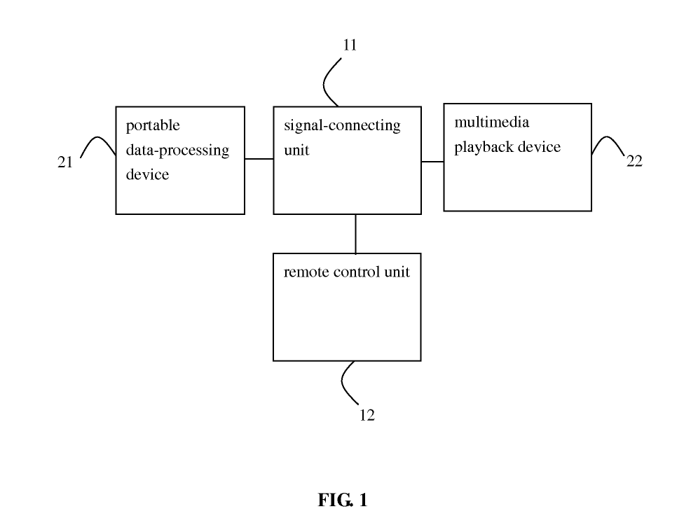

Referring to FIG. 1, a schematic diagram of a multimedia signal control device according to the present invention is provided. As shown, in the present embodiment, the multimedia signal control device includes a signal-connecting unit 11 and a remote control unit 12, and the multimedia signal control device can be connected to a portable data-processing device 21 and a multimedia playback device 22. Examples of the portable data-processing device 21 include, but not limited to, a mobile phone and a tablet computer. The multimedia playback device 22 may be, for example, an LCD device, a TV set, an AV amplifier, an active woofer speaker, an audio player, an automobile audio system or any other multimedia audio or video playback devices.

In one embodiment, the signal-connecting unit 11 includes more than one wired transmission ports, wired connection terminals or wireless transmission ports supporting the same or different signal transmission specifications. (For example, wireless transmission ports that support infrared transmission, Bluetooth transmission or wireless signal transmission of 2.4 GHz or 5.8 GHz specifications.) Therefore, the portable data-processing device 21 and the multimedia playback device 22 can be connected in a wired or wireless manner. In practice, the signal-connecting unit 11 may have at least one end provided with a wired transmission port supportive to a certain signal transmission specification, so that the portable data-processing device 21 can be connected to the signal-connecting unit 11 through a transmission wire meeting the specification requirement. Also, the signal-connecting unit 11 may have its another end provided with a terminal supportive to a different signal transmission specification, so that multimedia playback device 22 can be connected to the signal-connecting unit 11 through the terminal. As a result, the multimedia signal transmission between the portable data-processing device 21 and the multimedia playback device 22 through the signal-connecting unit 11 is established.

It is to be understood that the wired transmission ports, wired connection terminals or wireless signal transmission ports may be provided at any locations on the signal-connecting unit 11 in any amounts as applicable. In addition, any of the wired transmission ports, wired connection terminals and wireless transmission ports may be selected as signal input/output ports.

Moreover, the signal-connecting unit 11 is also used to convert the multimedia signal outputted by either of the portable data-processing device 21 and the multimedia playback device 22 to a multimedia signal processible to the other, and to transmit the converted signal to the other. For performing signal conversion, the signal-connecting unit 11 at least includes a processing unit, a memory module and a signal conversion program module. Since these components and the above-mentioned transmission ports as well as terminals are well known in the art, and they should not be regarded as any major features of the present invention, no further detail will be elaborated in the following description.

In the present embodiment, the signal-connecting unit 11 may be a multimedia docking system, a set-top box, a KVM (keyboard, mouse, and monitor) or a signal conversion console that is optionally provided at one end with a signal transmission port that supports MHL transmission and is configured to connect with the portable data-processing device 21, and at another end with a signal transmission port that supports HDMI transmission and is configured to connect with the multimedia playback device 22. Of course, in practical use, other signal transmission formats may also be utilized in addition to the foregoing MHL transmission or HDMI transmission. Examples of the optional signal transmission formats may include a 30-pin or 8-pin format compatible with iPhone or iPad produced by Apple Inc., a Micro USB format and a CVBS (Color, Video, Blanking, and Sync.) format. In the case of wireless transmission, an infrared format, a Bluetooth format or a format compatible with 2.4 GHz or 5.8 GHz wireless transmission may also be implemented.

The remote control unit 12 may be connected to the signal-connecting unit 11 in a wired or wireless communication. In the case of wireless connection, infrared, Bluetooth or 2.4 GHz or 5.8 GHz wireless transmission technologies may be implemented to perform control signal communication with the signal-connecting unit 11. Thus, through the connection between the signal-connecting unit 11 and the portable data-processing device 21 or the connection between the signal-connecting unit 11 and the multimedia playback device 22, the control signal can be transmitted to the portable data-processing device 21 or the multimedia playback device 22, thereby controlling operation of the portable data-processing device 21 or the multimedia playback device 22. For example, the portable data-processing device 21 plays the multimedia signal, pauses the playback, and adjusts the volume in accordance with the control signal, as well as the multimedia playback device 22 that can be directly controlled to play the multimedia signal, to pause the playback, and to adjust the volume.

It is to be noted that while the signal-connecting unit 11 in the present embodiment connects one portable data-processing device 21 and one multimedia playback device 22, in practical use, the signal-connecting unit 11 may connect more than one portable data-processing device 21 and/or more than one multimedia playback device 22 at the same time. The signal-connecting unit 11 uses the foregoing signal transmission and conversion techniques implemented between it and the portable data-processing devices 21 and between it and the multimedia playback device 22 to facilitate signal transmission and conversion among different signal formats between the portable data-processing devices 21 and/or the multimedia playback devices 22. In the embodiments where multiple portable data-processing devices 21 and/or plural multimedia playback devices 22 are involved, the remote control unit 12 may further control the signal-connecting unit 11 to switch among the portable data-processing devices 21 and/or among the plural multimedia playback devices 22 for signal conversion and transmission.

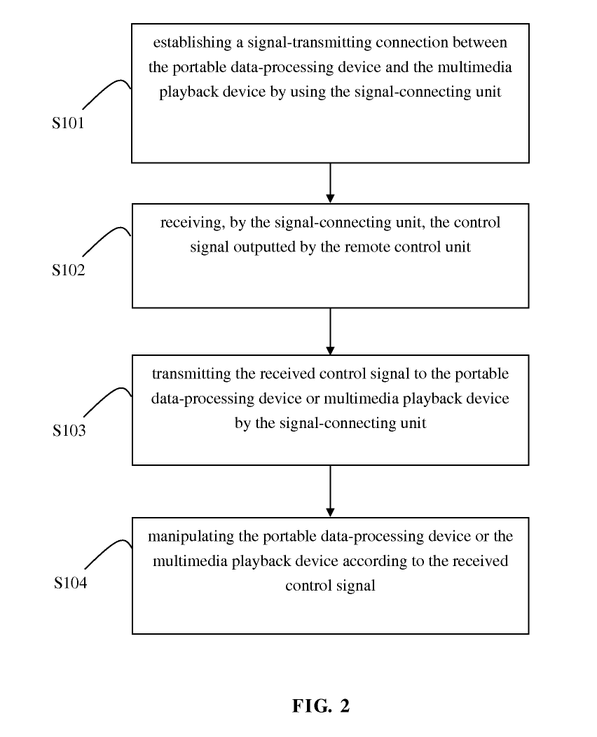

Please refer to FIG. 2 for a flowchart of a method for controlling a multimedia signal using the multimedia signal control device of the first embodiment of the present invention. The present embodiment is implemented under the structure of the disclosed multimedia signal control device. As shown, in step S101, a signal-transmitting connection between the portable data-processing device and the multimedia playback device is established through the signal-connecting unit having wired transmission ports, wired connection terminals or wireless signal transmission ports of the same or different signal transmission forms. Then the method proceeds with a subsequent step S102.

In the step S102, the signal-connecting unit receives the control signal outputted by the remote control unit in a wireless or wired manner. Then the method proceeds with a subsequent step S103.

In the step S103, the signal-connecting unit uses its connection with the portable data-processing device or with the multimedia playback device to transmit the control signal it receives to the portable data-processing device or to the multimedia playback device. Then the method proceeds with a subsequent step S104.

In the step S104, the portable data-processing device or the multimedia playback device plays the multimedia signal, pauses the playback, or adjusts the playback volume in response to the received control signal.

A second embodiment of the present invention will be elaborated in the following description. The second embodiment is primarily based on the device and practice environment disclosed in the first embodiment and provides a more particular aspect of the present invention. Since all the components similar to their counterparts in the first embodiment will not be discussed in any length herein, the following description is to be read in conjunction with FIG. 1.

In the present embodiment, the signal-connecting unit 11 connects the portable data-processing device 21 and the multimedia playback device 22 in a wired or wireless manner, and converts the multimedia signal outputted by the portable data-processing device 21 in a first signal format into a multimedia signal in a second signal format that can be recognized and processed to the multimedia playback device 22. In other words, the second signal format is recognizable and processible to the multimedia playback device 22. The signal-connecting unit 11 then transmits the converted signal to the multimedia playback device 22. The first signal format may be, for example, an MHL format, while the second signal format may be, for example, an HDMI format.

The remote control unit 12 is connected to the signal-connecting unit 11 for transmitting the control signal to the signal-connecting unit 11 in a wired or wireless manner, and then the signal-connecting unit 11 uses one of its wired transmission ports, wired connection terminals or wireless signal transmission ports to transmit the control signal to the portable data-processing device 21.

The portable data-processing device 21, in response to the control signal outputted by the remote control unit 12 and transmitted through the signal-connecting unit 11, outputs a multimedia signal in the corresponding MHL format to the signal-connecting unit 11. The signal-connecting unit 11 then performs proper signal conversion to convert the multimedia signal in the MHL format into a multimedia signal in the HDMI format, and transmits the converted signal to the multimedia playback device 22, so that the multimedia playback device 22 plays the received multimedia signal.

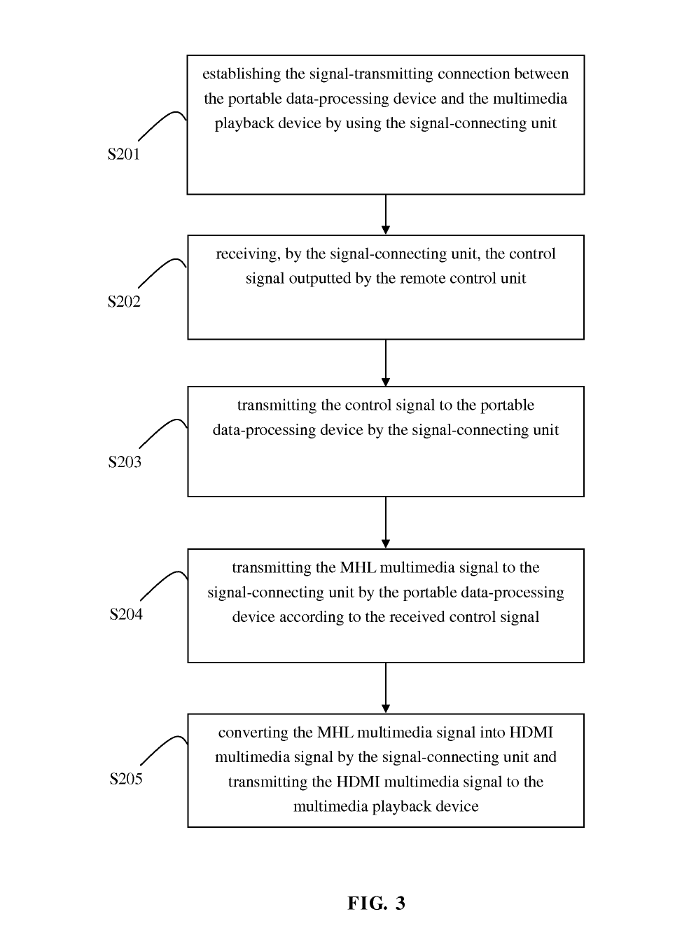

Please refer to FIG. 3, which is a flowchart of a method for controlling a multimedia signal using the multimedia signal control device of the second embodiment of the present invention. As shown, in step S201, the signal connection between the portable data-processing device and the multimedia playback device is established through the signal connecting unit. Then, in step S202, the signal-connecting unit receives the control signal outputted by the remote control unit. Afterward, in step S203, the signal-connecting unit transmits the control signal it receives to the portable data-processing device. In the subsequent step S204, the portable data-processing device, in response to its receipt of the control signal, transmits the multimedia signal in the corresponding MHL format to the signal-connecting unit. In the later step S205, the signal-connecting unit converts the multimedia signal in the MHL format into a multimedia signal in the HDMI format, and transmits the converted multimedia signal to the multimedia playback device, so that the multimedia playback device plays the multimedia signal.

The multimedia signal control device and method disclosed in the embodiments of the present invention use the remote control unit to connect with the signal-connecting unit, so user can conveniently use the remote control unit to control the portable data-processing device and multimedia playback device interconnected through the signal-connecting unit, without the need to directly operate the portable data-processing device, thereby improving convenience and flexibility for users.

What is claimed is:

1. A multimedia signal control device, for connecting and controlling a portable data-processing device and a multimedia playback device, the multimedia signal control device comprising:
a signal-connecting unit connected to the portable data-processing device and to the multimedia playback device, converting a multimedia signal outputted by either of the portable data-processing device and the multimedia playback device into a converted multimedia signal processible to the other of the portable data-processing device and the multimedia playback device, and transmitting the converted multimedia signal to the other of the portable data-processing device and the multimedia playback device; and
a remote control unit connected to the signal-connecting unit, transmitting a control signal to the signal-connecting unit, wherein the signal-connecting unit transmits the control signal to the portable data-processing device or the multimedia playback device, so as to control the operation of the portable data-processing device or the multimedia playback device.

2. The multimedia signal control device of claim 1, wherein the multimedia signal outputted by the portable data-processing device or by the multimedia playback device is in an MHL (Mobile High-Definition Link) format, a 30-pin or 8-pin format compatible with iPhone or iPad produced by Apple Inc., a Micro USB format, a CVBS format, an infrared format, a Bluetooth format or a format compatible with 2.4 GHz or 5.8 GHz wireless transmission.

3. The multimedia signal control device of claim 1, wherein the converted multimedia signal processible to the portable data-processing device or the multimedia playback device is in an HDMI (High Definition Multimedia Interface) format, a 30-pin or 8-pin format compatible with iPhone or iPad produced by Apple Inc., a Micro USB format, a CVBS format, an infrared format, a Bluetooth format or a format compatible with 2.4 GHz or 5.8 GHz wireless transmission.

4. The multimedia signal control device of claim 1, wherein the remote control unit transmits the control signal to the signal-connecting unit through a wired or wireless communication.

5. The multimedia signal control device of claim 1, wherein the signal-connecting unit is connected to the portable data-processing device and the multimedia playback device through a wired or wireless communication.

6. The multimedia signal control device of claim 1, wherein the signal-connecting unit is connected to a plurality of the portable data-processing devices or a plurality of the multimedia playback devices for conducting signal conversion and transmission between the signal-connecting unit and the portable data-processing devices or between the signal-connecting unit and the multimedia playback devices, and the remote control unit controls the signal-connecting unit to switch signal conversion and transmission between the signal-connecting unit and the portable data-processing devices and/or between the signal-connecting unit and the multimedia playback devices.

7. A multimedia signal control device, for connecting and controlling a portable data-processing device and a multimedia playback device, the multimedia signal control device comprising:
a signal-connecting unit connected to the portable data-processing device, converting a multimedia signal in a first signal format outputted by the portable data-processing device into a multimedia signal in a second signal format recognizable and processible to the multimedia playback device, and transmitting the converted multimedia signal to the multimedia playback device; and
a remote control unit connected to the signal-connecting unit, transmitting a control signal to the signal-connecting unit so that the signal-connecting unit transmits the control signal to the portable data-processing device,
wherein, the portable data-processing device outputs, in response to the control signal, the multimedia signal in the first signal format to the signal-connecting unit, and the signal-connecting unit converts the multimedia signal in the first signal format into the multimedia signal in the second signal format and then transmits the converted multimedia signal to the multimedia playback device.

8. The multimedia signal control device of claim 7, wherein the first signal format is in an MHL (Mobile High-Definition Link) format, a 30-pin or 8-pin format compatible with iPhone or iPad produced by Apple Inc., a Micro USB format, a CVBS format, an infrared format, a Bluetooth format or a format compatible with 2.4 GHz or 5.8 GHz wireless transmission.

9. The multimedia signal control device of claim 7, wherein the second signal format is in an HDMI (High Definition Multimedia Interface) format, a 30-pin or 8-pin format compatible with iPhone or iPad produced by Apple Inc., a Micro USB format, a CVBS format, an infrared format, a Bluetooth format or a format compatible with 2.4 GHz or 5.8 GHz wireless transmission.

10. The multimedia signal control device of claim 7, wherein the remote control unit transmits the control signal to the signal-connecting unit through a wired or wireless communication.

11. The multimedia signal control device of claim 7, wherein the signal-connecting unit connects to the portable data-processing device and the multimedia playback device through a wired or wireless communication.

12. The multimedia signal control device of claim 7, wherein the signal-connecting unit connects to a plurality of the portable data-processing devices or a plurality of the multimedia playback devices for signal conversion and transmission between the signal-connecting unit and the portable data-processing devices or between the signal-connecting unit and the multimedia playback devices, and the remote control unit controls the signal-connecting unit to switch signal conversion and transmission among between the signal-connecting unit and the portable data-processing devices and/or between the signal-connecting unit and the multimedia playback devices.

13. A method for controlling a multimedia signal, the method comprising the following steps:
establishing a signal-transmitting connection between a portable data-processing device and a multimedia playback device by using a signal-connecting unit;
receiving a control signal from a remote control unit by using the signal-connecting unit;
transmitting the received control signal to the portable data-processing device or the multimedia playback device by using the signal-connecting unit; and
manipulating the portable data-processing device or the multimedia playback device according to the received control signal.

14. A method for controlling a multimedia signal, the method comprising the following steps:
establishing a signal-transmitting connection between a portable data-processing device and a multimedia playback device by using a signal-connecting unit;
receiving a control signal from a remote control unit by using the signal-connecting unit;
transmitting the received control signal to the portable data-processing device by using the signal-connecting unit;
transmitting a multimedia signal in a first signal format to the signal-connecting unit by using the portable data-processing device according to the received control signal; and
converting the multimedia signal in the first signal format into a multimedia signal in a second signal format by using the signal-connecting unit and transmitting the converted multimedia signal to the multimedia playback device by using the signal-connecting unit.
